(19) United States
(12) Patent Application Publication
(10) Pub. No.: US 2026/0219650 A1
(43) Pub. Date: Jul. 30, 2026

(54) FRAMEWORK SYSTEM FOR ROBOTIC ARCHITECTURE AND METHOD THEREFOR

(71) Applicant: HighRes Biosolutions, Inc., Beverly, MA (US)

(72) Inventors: Matthew JOHNSEN, Ipswich, MA (US); Roy SCAMMELL, Derry, NH (US); Ian LOCKE, Methuen, MA (US); Pedram Sotoodeh SHAHNANI, San Diego, CA (US); Nigel COCHRAN, Stoneham, MA (US); Matthew MORIN, Salem, NH (US); Robert CONNORS, Wakefield, MA (US)

(21) Appl. No.: 19/456,274

(22) Filed: Jan. 22, 2026

Related U.S. Application Data
(60) Provisional application No. 63/748,561, filed on Jan. 23, 2025.

(51) Int. Cl. G05B 19/4155

(52) U.S. Cl. CPC G05B 19/4155; G05B 2219/31392

(57) ABSTRACT

A framework system for robotic architecture for a laboratory space includes a chassis providing a common selectable variable mounting interface for selectably mounting different module units the chassis. An operative common interface, connected to the chassis, has a input/output side. At the input/output side, the common interface has a common communication signal connection interface and a common safety signal connection interface. The common communication signal connection interface has different connectors that configure the signal connection interface to conform and communicably connect with corresponding different selected module units. The safety signal connection interface sends a safety related command, from a common controller to at least one of the different selected module units. The operative common interface has a controller side to couple with the common controller and so that input/output signals are communicated to and from the common controller and to and from respective different selected module units.

### CROSS-REFERENCE TO RELATED APPLICATIONS

This application is a non-provisional of and claims the benefit of U.S. provisional patent application No. 63/748,561 filed on Jan. 23, 2025, the disclosure of which is incorporated herein by reference in its entirety.

### BACKGROUND

### 1. Field

The exemplary embodiments generally relate to life sciences equipment, and more particularly, to automated handling and processing of life sciences equipment.

### 2. Brief Description of Related Developments

Scientific experimentation in the life sciences industry is generally performed in one or more work cells where processing equipment (e.g., dispensers, incubators, readers, spinners, defrosters, freezers, decappers/cappers, hotels, etc.) are disposed adjacent one another in groups to form a respective work cell. One type of automation tool employed in the work cells is a mobile cart that is used to carry items from one location to another within the laboratory facility. These mobile carts generally interact with other automated processing equipment and may be used to transfer laboratory samples and/or engage a processing station so that the samples carried by the mobile cart may be processed by the processing station.

The processing equipment and automation tools of the work cells generally communicate with a controller or each other by wired communication. This wired communication is facilitated with many different connection types. Connecting the processing equipment and automation tools in a work cell may be a time consuming process that requires skill sets not typically held by the operators of the laboratory equipment.

Accordingly, the present disclosure addresses a number of those issues.

### BRIEF DESCRIPTION OF THE DRAWINGS

The foregoing aspects and other features of the present disclosure are explained in the following description, taken in connection with the accompanying drawings, wherein:

FIG. 1 is an perspective illustration of an exemplary automatic or collaborative process facility having one or more automation system blocks in accordance with the present disclosure;

FIG. 2 is an perspective illustration of an exemplary automatic or collaborative process facility having one or more automation system blocks in accordance with the present disclosure;

FIG. 3A and FIG. 3B collectively referred as FIG. 3, is a schematic block diagram of a portion of an exemplary automatic or collaborative process facility, such as of FIGS. 1 and/or 2, in accordance with the present disclosure;

FIG. 4 is a schematic illustration of a portion of an automation system block of an automatic or collaborative process facility in accordance with the present disclosure;

FIG. 5 is a schematic block diagram of a portion of an exemplary automatic or collaborative process facility, such as of FIGS. 1 and/or 2, in accordance with the present disclosure;

FIG. 6 is a schematic illustration of a portion of an automation system block of an automatic or collaborative process facility in accordance with the present disclosure;

FIG. 7 is a schematic illustration of portion of an automation system block of an automatic or collaborative process facility in accordance with the present disclosure;

FIG. 8 is a schematic illustration of portion of an automation system block of an automatic or collaborative process facility in accordance with the present disclosure;

FIG. 9 is a schematic illustration of portion of an automation system block of an automatic or collaborative process facility in accordance with the present disclosure;

FIG. 10 is an exemplary illustration of signal shifting in accordance with the present disclosure;

FIG. 11 is a schematic illustration of portion of an automation system block of an automatic or collaborative process facility in accordance with the present disclosure;

FIG. 12 is a schematic illustration of portion of an automation system block of an automatic or collaborative process facility in accordance with the present disclosure;

FIG. 13 is an exemplary illustration of a mechanical sub-assembly of an automation system block in accordance with the present disclosure;

FIG. 14 is an exemplary illustration of a mechanical sub-assembly of an automation system block in accordance with the present disclosure;

FIG. 15 is an exemplary schematic block diagram of power distribution in the automatic or collaborative process facility in accordance with the present disclosure; and

FIG. 16 is an exemplary flow diagram of a method in accordance with the present disclosure.

### DETAILED DESCRIPTION

The following detailed description is meant to assist the understanding of one skilled in the art, and is not intended in any way to unduly limit claims connected or related to the present disclosure.

The following detailed description references various figures, where like reference numbers refer to like components and features across various figures, whether specific figures are referenced, or not.

The word “each” as used herein refers to a single object (i.e., the object) in the case of a single object or each object in the case of multiple objects. The words “a,” “an,” and “the” as used herein are inclusive of “at least one” and “one or more” so as not to limit the object being referred to as being in its “singular” form.

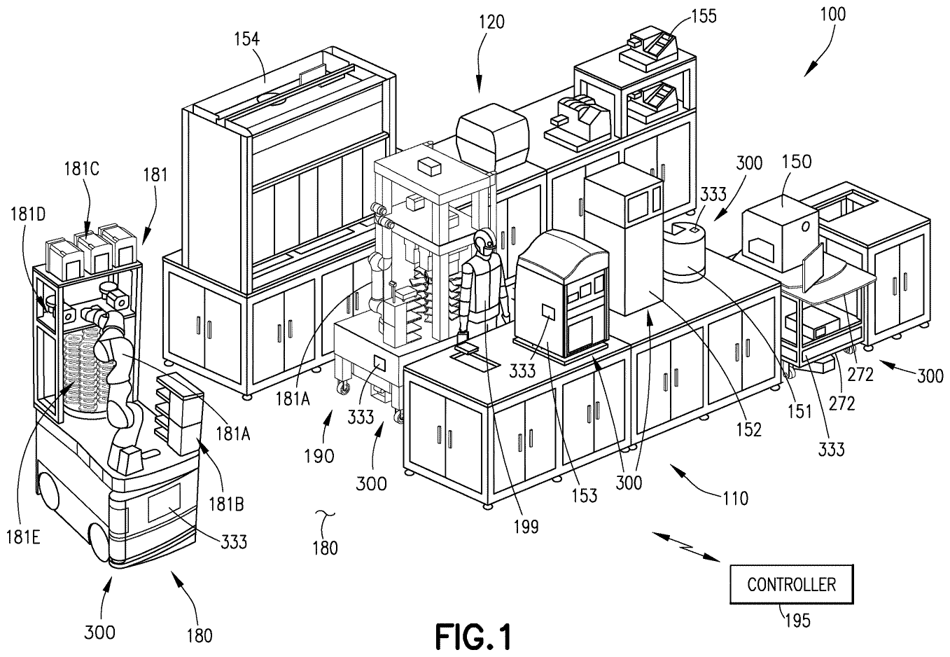

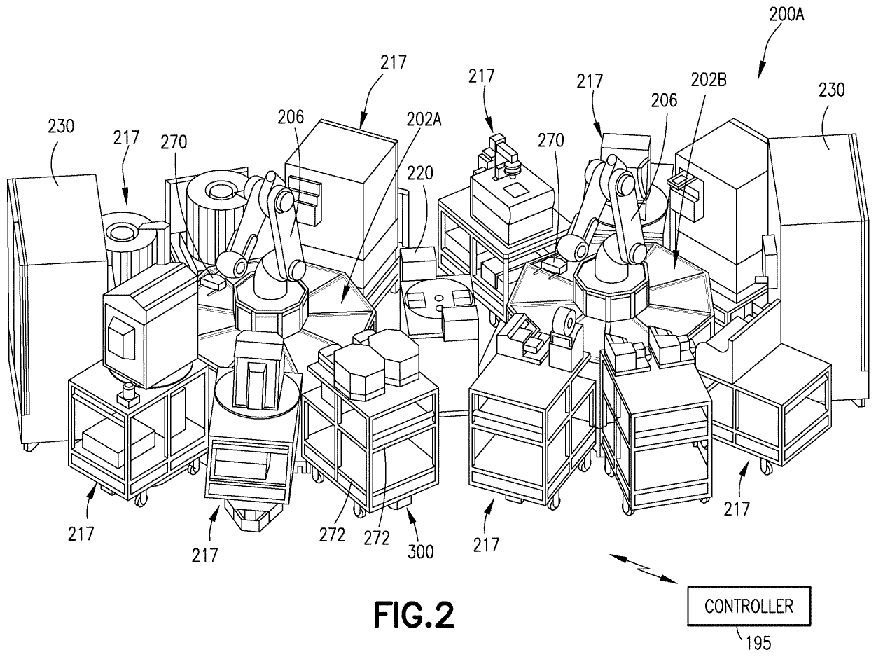

As used herein a “system block” is a term used to encompass the different elements of an automatic or collaborative workspace, such as the automated laboratory automation system illustrated in FIGS. 1 and 2. As an example, a robot, a table with a robot on it, a device (such as a labware and/or sample-processing device), a table with multiple devices, a mobile cart, etc. are each considered a system block. As such, the different components of the automatic or collaborative workspace will be referred to herein generally, as system blocks or automation system blocks.

FIG. 1 illustrates an exemplary automatic or collaborative laboratory facility, also referred to as automatic or collaborative process facility 100 in accordance with the present disclosure. Although the present disclosure will be described with reference to the drawings, it should be understood that the present disclosure can be embodied in many forms. In addition, any suitable size, shape or type of elements or materials could be used.

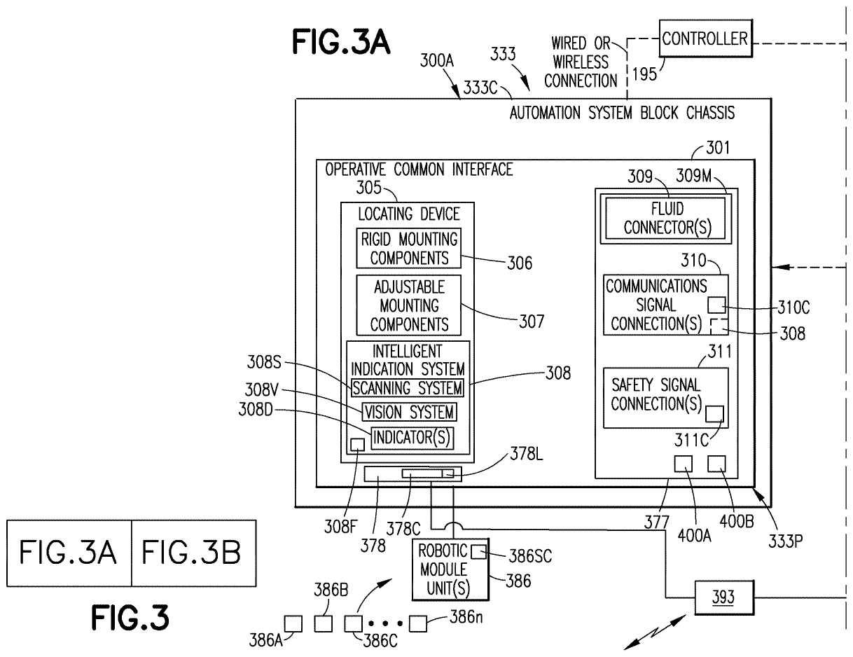

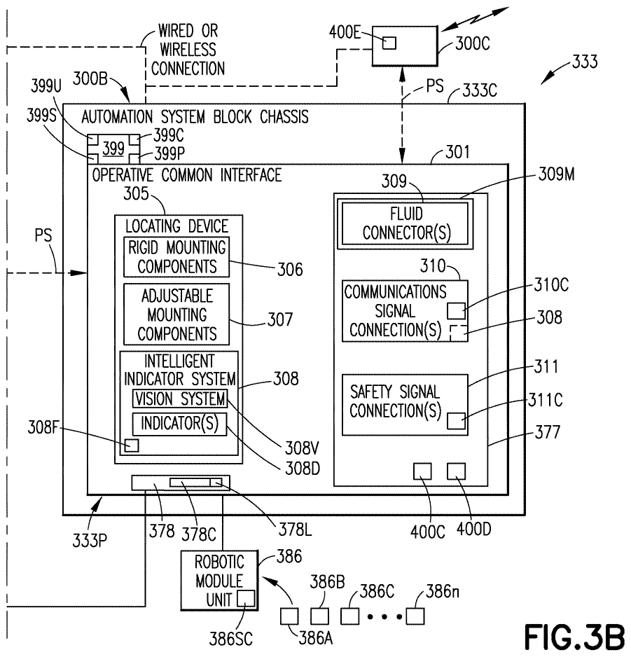

Referring also to FIG. 3, the present disclosure provides for a framework system 333 that may provide for a modular, interchangeable, and scalable robotic architecture for an automatic or collaborative workspace, such as a laboratory automation workspace. This framework system 333 may provide for one or more of: a standardized or common interface of and/or between automation system blocks; modularized functional sub-assemblies for signaling, fluid distribution, communications, and power distribution; signal-shifting to effect a standardized interface for different types of sensors/signals; a device that may stop a non-safety rated machine; a device that can integrate automation system blocks with the standardized interface; and adjustability of the automatic or collaborative workspace.

The standardized or common interface between the automation system blocks 300 may provide for one or more of the interchangeability of the automation system blocks and the selectable mounting different robotic module units (also referred to as module units) to the framework system 333, which may allow for reconfiguration and expansion of the laboratory facility or automatic or collaborative process facility 100 as desired by an end user. The framework system 333 may reduce the skill set required of laboratory personnel to swap or add automation system blocks in the laboratory facility or automatic or collaborative process facility 100.

The modularized functional sub-assemblies may provide for one or more of: general signaling including input/output (I/O) and corresponding components; safety signaling including input/output (I/O) and corresponding components; fluid (e.g., gas or other fluid) distribution; networking, including but not limited to TCP/IP, parallel networking, and serial networking; and power (e.g., alternating current and/or direct current) distribution. Types of serial networking (and respective connectors) that may be provided in accordance with the present disclosure include, but are not limited to, I2C (inter-integrated circuit), RS-232, RS-485, USB (types A, B, C, mini, etc.), UART, Transistor-Transistor Logic (TTL) protocol and/or any other suitable serial networking protocol/connection interface. Types of parallel networking (and respective connectors) that may be provided in accordance with the present disclosure include, but are not limited to, PCT, SCSI, LPT, and IDE.

Still referring to FIG. 1, the automatic or collaborative process facility 100 may be substantially similar to that described in U.S. patent application Ser. No. 18/970,333 filed on Dec. 5, 2024 and titled “Mobile Robotic Processing Station, Processing System, and Method Therefor,” and U.S. Pat. No. 10,955,430 issued on Mar. 23, 2021 and titled “Auto-navigating Robotic Processing Vehicle,” the disclosures of which are incorporated herein by reference in their entireties.

The laboratory facility 100 may include at least one auto-navigating robotic processing vehicle 180, 190 (which may be referred to as automation system blocks) and at least one processing station 110, 120. The at least one processing station 110, 120 may be a human operated processing station and/or an automated processing station. One or more processing stations may be communicably coupled so as to form a work cell. The auto-navigating robotic processing vehicles 180, 190 include a processing section 181 that has a number of different processing modules 181A-181E. Each of the different processing modules 181A-181E has a different predetermined laboratory processing function with a different predetermined function characteristic corresponding to the processing module 181A-181E. The different processing modules 181A-181E and their respective functions are automatically selectable to effect, independent of or in combination with vehicle travel, a preprocess or a preprocess condition of laboratory samples and/or sample holders with respect to a process at the at least one processing station 110, 120. For example, preprocessing conditions that may be performed by the at least one auto-navigating robotic processing vehicle 180, 190 include, but are not limited to, storage of sample trays, sample tray lids, transport and direct or indirect handoff of laboratory equipment (e.g., vacuum heads, brushes, Bunsen burners, microscopes, brooms, processing tools and/or fixtures, sample trays, etc.) to a human 199 (at a processing station 110, 120) and/or automated processing equipment at a processing station 110, 120 cleaning of an animal cage, laboratory table, etc., Examples of processes that may be performed by the at least one auto-navigating robotic processing vehicle 180, 190 include, but are not limited to, removing a sealing film from a sample and/or sample tray, reading an identification of a sample and/or sample tray, etc., pipetting fluids, capping and decapping tubes.

The at least auto-navigating robotic processing vehicle 180, 190 may service individual processing stations 110, 120, where the processing stations 110, 120 have either automatic item (e.g., tools, samples, trays, etc.) input/output or have manual processes which are carried out/effected, monitored, and/or controlled (e.g., through a user interface) by a human 199. The at least one auto-navigating robotic processing vehicle 180, 190 may be configured to provide all comporting (e.g., suitable) equipment (e.g., “process payloads” which may include process modules, peripherals, and/or consumables for station engagement, or “workpiece payloads” which may include samples and sample trays for station engagement) on the auto-navigating robotic processing vehicle 180, 190 to perform the tasks at a given processing station 110, 120. As an example, an auto-navigating robotic processing vehicle 180, 190 may be configured and loaded for an individual task such that all the comporting equipment is carried by a single auto-navigating robotic processing vehicle 180 190 to complete the individual task (which may be, e.g., a process station function) in full with a single auto-navigating robotic processing vehicle 180, 190 and the items carried thereon.

The at least one auto-navigating robotic processing vehicle 180, 190 may provide or otherwise generate, at each different human affectable process station 110, 120 (e.g., that has a common type of station process function, that includes one or more manual steps such as human affectable processes that include sterilization, exact timing control, climate control, temperature control, unattended use, remote control or monitoring) repeatable or “near identical” process steps (e.g., the process steps are performed with automatic machine repetition controlled by the at least one auto-navigating robotic processing vehicle's 180, 190 programmable controller).

Still referring to FIG. 1 and also to FIG. 2, the processing stations 110, 120 may be linearly arranged with one or more process tools 150-155 which may include, but are not limited to, electronic pipettes 153, microplate dispensers 150, media preparation modules 155 (e.g., sterilization and dispensing of sample medium), environmental control modules 152 (e.g., refrigeration, freezers, incubators, clean environments, hoods, etc.), storage modules 154, and centrifuges 151, each of which may be referred to as an automation system block. It is noted that FIG. 1 illustrates human processing stations 110, 120, which may or may not include automated processes however, the present disclosure is not limited to the human processing stations 110, 120. For example, the at least one auto-navigating robotic processing vehicle 180, 190 may be configured to effect one or more predetermined laboratory processing function at a processing station of an automated configurable processing tool 200A. For example, the automated configurable processing tool 200A (shown for example, having a cluster configuration as described in U.S. Pat. No. 8,734,720 issued on May 27, 2014, although the processing tool may have a linear configuration, a suitable example of which is disclosed in U.S. Pat. No. 11,045,811 issued on Jun. 29, 2021, the disclosures of which are incorporated herein by reference in their entireties), may include at least one automated unit 202A, 202B each having a multi-axis robotic arm 206 (which may be referred to as an automation system block) that interfaces with one or more stations 217 (which may be referred to as automation system blocks, in this example, mobile carts) docked with a stationary base of the multi-axis robotic arm 306 (while in other examples the auto-navigating robotic processing vehicle 180, 190 may dock with the automated configurable processing tool 200A in the same/similar manner as the mobile cart). Each automated unit 202A, 202B may include a respective controller 230. An interface station 220 (which may be referred to as an automation system block) may also be provided for transferring material between the at least one automated units 202A, 202B. The at least one auto-navigating robotic processing vehicle 180, 190 may be configured to perform a process or preprocess condition at the at least one automated unit 202A, 202B such as by providing different end effectors 270 or other tools to the multi-axis robotic arm 306, and/or performing a pre-process condition (such as those described above) at one or more of the stations 217. The auto-navigating robotic processing vehicle 180, 190 and the automated configurable processing tool 200A are communicably connected by any suitable network to the laboratory facility 100 controller 195 (e.g., laboratory-wide controller) that registers the configuration of the automated configurable processing tool 200A, a presence and configuration of the auto-navigating robotic processing vehicle 180, 190 at the automated configurable processing tool 200A or in motion from/to the automated configurable processing tool 200A, and register a location and configuration of a human processing station 110, 120 and a status (e.g., operating, occupied, closed, etc.) thereof.

The present disclosure may provide for coupling of two or more automation system blocks 300A, 300B, 300C (such as any two or more of those automation components/system blocks 300 described above with respect to FIGS. 1 and 2) to each other and/or coupling one or more different robotic module units 386A-386n (generally 386) to a respective automation system block 300. For example, the present disclosure provides the framework system 333 for a robotic architecture (e.g., such as the vehicles, process stations, process tools, etc. and/or a collection/assembly of vehicles, process stations, process tools, etc. as described with respect to FIGS. 1 and 2) for a laboratory space (e.g., such space as that described with respect to FIGS. 1 and 2, including but not limited to the laboratory facility 100 and/or tool 200A). The framework system 333 includes a chassis 333C and an operative common interface 301 (also referred to as a standardized interface). The framework system 333 may form a basis for one or more respective system block 300.

The chassis 333C is configured to provide a common selectable variable mounting interface 305 for selectably mounting different robotic module units 386 (such as robotic arms, specimen analyzers, etc. such as the different automated processing equipment described above with respect to FIGS. 1 and 2) of the robotic architecture to the chassis 333C so as to assembly different selectable robotic module units 386 to the chassis 333C forming different robotic architectures (e.g., such as described with respect to FIGS. 1 and 2), each having different bot architecture characteristics. The different robotic module units 386 each have different robotic characteristics and is mounted to and removed from the chassis 333C as a unit. The different robotic module units 386 may be selected from a number of different robotic module units 386A-386n for coupling to the chassis.

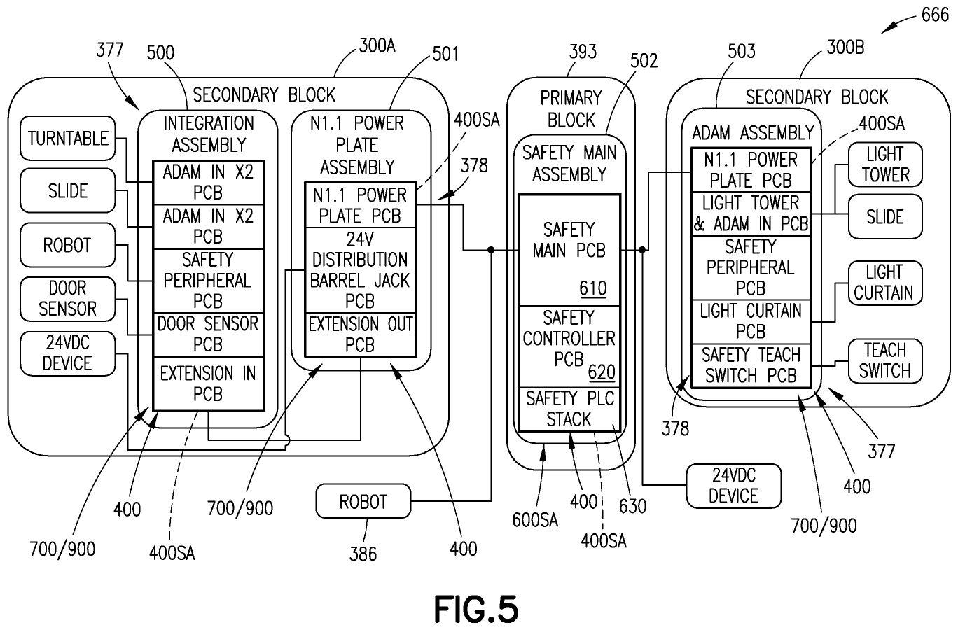

The operative common interface 301 is connected to the chassis 333C in any suitable manner (such as with any suitable fasteners). The operative common interface 301 operatively interfaces the assembly of different selected robotic module units 386 and a common controller 393 of the different robotic module units 386, although one or more robotic module units 386 may be operatively interfaced substantially directly with the common controller 393 (see FIG. 5). The operative common interface 301 has a module input/output (I/O) side 377 (e.g., that effects coupling of one or more robotic module units 386) and a controller side 378 (e.g., that effects coupling with the common controller 393).

At the module input/output side 377, the operative common interface 301 has a common communication signal connection interface 310 that is selectably variable (as described herein), and a common safety signal connection interface 311 that is selectably variable (as described herein). The common communication signal connection interface 310 has different connectors 310C. Each of the different connectors 310C have different coupling characteristics that conform with respective connectors of the different robotic module units 386. The different connectors 310C are selectable so as to configure the common communication signal connection interface 310 to conform and communicably connect with corresponding different selectable robotic module units 386 of the assembly forming the different robotic architectures. For example, the different connectors 310C may include one or more of serial type networking connectors and parallel type networking connectors. The serial type networking connectors may be, but are not limited to, I2C (inter-integrated circuit), RS-232, RS-485, USB (types A, B, C, mini, etc.), UART, Transistor-Transistor Logic (TTL) protocol, and/or any other suitable serial networking protocol/connection interface. The parallel type networking connectors may be, but are not limited to, PCT, SCSI, LPT, and IDE connectors. Other suitable connectors that may be included in the different connectors 310C include, but are not limited to, Ethernet® connectors, one or more electrical connectors (such as M8, M12, or other suitable connectors), EtherCAT® connectors, and/or other suitable connectors configured for communications signal transfer.

At least one of the different connectors 310C of the common communication signal connection interface 310 has a plug and play connection characteristic. For example, at least one of the different connectors 310C of the common communication signal connection interface 310 is configured so as to, upon coupling, initialize an identification query of at least one of the different robotic module units 386 coupled thereto, and is disposed to receive a self-identification signal (e.g., from the at least one of the different robotic module units 386 coupled thereto) in reply. The reply may be sent to the common controller 393 so that the automation system block 300 is automatically configured to operate with the at least one of the different robotic module units 386 coupled thereto and identified through the plug and play connection characteristic. The common controller 393 may be in communication (e.g., through any suitable wired or wireless connection) with the controller 195, although one or more of the system blocks 300 may be in substantial direct communication with one or more of the controller 195 and the common controller 393.

The common safety signal connection interface 311 is configured so as to communicably connect (e.g., through any suitable connectors 311C) with respective safety signal connectors 386SC of corresponding different selected robotic module units 386 of the assembly of different selectable robotic module units (e.g., such as forming a robotic processing vehicle, process station, process tool, etc. described herein) and send a safety related command, from the common controller 393, of the different selected robotic module units 386, to at least one of the different selected robotic module units 386 forming the different robotic architectures (e.g., for at least one of the different robotic architectures, the safety related command is sent from the common controller to the at least one different selected robotic module unit(s) 386 of a respective robotic architecture (e.g., process vehicle, process station, process tool, etc.) of which the selected robotic module unit(s) 386 are a part). The different connectors 311C may include one or more of serial type networking connectors and parallel type networking connectors. The serial type networking connectors may be, but are not limited to, I2C (inter-integrated circuit), RS-232, RS-485, USB (types A, B, C, mini, etc.), UART, Transistor-Transistor Logic (TTL) and/or any other suitable serial networking protocol/connection interface. The parallel type networking connectors may be, but are not limited to, PCT, SCSI, LPT, and IDE connectors. Other suitable connectors that may be included in the different connectors 311C include, but are not limited to, Ethernet® connectors, one or more electrical connectors (such as M8, M12, or other suitable connectors such as M-style connectors falling under the IEC 61073-2 and 61076-2 standards, C-style connectors falling under the IEC 60320 standard or their equivalents, etc.), EtherCAT® connectors, one or more contactless and safety rated infrared sensor pairs (e.g., at least one of a safety rated connector such as the contactless safety rated, IR sensor although other suitable safety rated contact or contactless sensor may be included), and/or other suitable connectors configured for safety signal transfer (such as, for example, those connectors falling under the IEC 61984 standard or its equivalent).

The controller side 378, of the operative common interface 301, has a common interface 378C having a common coupling 378L so as to couple with the common controller 393 and so that input/output signals, including communication signals and safety related commands, are communicated to and from the common controller 393 and to and from the respective different selected robotic module units 386 of the different robotic architectures. The common coupling 378L is common to each of the different robotic architectures and has a substantially invariant configuration.

The common selectable variable mounting interface 305, the selectably variable communication signal connection interface 310, the selectably variable common safety signal connection interface 311, and the controller side 378 common interface 378C (that is substantially invariant with respect to each of the different robotic architectures) may provide a framework system 333 that defines a plug and play, modular, interchangeable, and scalable (via variance in the number of and type of the different selected robotic module units assembled) robotic architecture.

As described herein, at the module input/output side 377 the operative common interface 301 has a pneumatic feed manifold 309M with different pneumatic feed couplings or fluid connectors 309 with feed characteristics that conform with respective pneumatic feed demands of different robotic module units 386 assembled to the chassis 333C. The fluid connector(s) or feed couplings 309 may include connections for such fluids including, but not limited to, compressed air, nitrogen, carbon dioxide, vacuum, and other gases, liquids, and/or vapors. For example, the feed manifold 309M includes at least one of a nitrogen gas feed coupling, a compressed air feed coupling, a carbon dioxide gas feed coupling, and a vacuum feed coupling.

As noted above, the operative common or standardized interfaces 301 may include, but are not limited to, one or more of: the common selectable variable mounting interface 305 (also referred to as a locating device); fluid connector(s) or feed coupling(s) 309; the common communication signal connection interface 310; and the common safety signal connection interface 311.

The common selectable variable mounting interface 305 may define a rigid mounting pattern that couples one automation system block 300A, 300B to another of the automation system blocks 300A, 300B. The common selectable variable mounting interface 305 may include adjustable mounting components 307 such as, but not limited to, locating pins, clips, latches, etc. The common selectable variable mounting interface 305 may have at least one interface mount 306, 307 that combined with at least one corresponding communication connector 310C of the common communication signal connection interface 310, and with at least one safety signal connector 311C of the common safety signal connection interface 311 form a common framework integration coupling 333P that couples at least one of the robotic module units 386 to the robotic architecture via the framework system 333.

The common selectable variable mounting interface 305 or the common communication signal connection interface 310 may include an intelligent indication (signal) system 308 disposed to send a signal to the common controller 393 of an accepted installation (e.g., at least one of a successful mounting, a successful communication signal coupling, and a successful safety signal coupling) of at least one robotic module unit 386 in the framework system 333 so as to integrate the at least one robotic module unit 386 via the framework system 333 to the robotic architecture. The intelligent indication system 308 may include at least one of a vision system 308V or scanning system 308S disposed so as to read a readable fiducial (e.g., vision fiducial, one-dimensional code, two-dimensional code) as described herein) associated with and that embodies identification information of the at least one robotic module unit 386 that is acceptably installed.

The vision system 308V may be, e.g., any suitable two-dimensional and/or three-dimensional cameras, etc. and the scanning system 308S may be, e.g., any suitable code readers, line scanner, etc.).

The intelligent indication system 308 may employ (or otherwise include) any suitable fiducials or vision targets 308F disposed on one or more of the system blocks 300A, 300B. The vision system 308V and/or scanning system 308S is configured to read the fiducial(s) 308F and determine the relative location between system blocks 300A, 300B to be communicably coupled. The fiducials 308F may be any suitable fiducials including, but not limited to, QR codes, Data Matrix codes, 2D barcodes, Aztec codes, and/or any other suitable code that effects location determination. The fiducials 308F may be integral to the system blocks 300A, 300B or removably coupled thereto (e.g., such as a golden plate including the fiducial that is placed into a holding location of a system block 300A, 300B for imaging by the vision system 308V and/or scanning system 308S—where a “golden plate” is a calibrated reference plate that has precise, precisely measured markings (i.e., the fiducial(s)) that serve as the standard for accuracy when determining precise locations within a specific area (i.e., the location of one system block relative to another system block)). An exemplary vision system employing vision targets for location is described in U.S. patent application Ser. No. 18/970,333 filed on Dec. 5, 2024 and titled “Mobile Robotic Processing Station, Processing System, and Method Therefor,” the disclosure of which is incorporated herein by reference in its entirety.

The intelligent indication system 308 may include one or more aural or visual indicator(s) 308D that effect informing laboratory personnel when one system block 300A, 300B is in an acceptable location relative to another system block 300A, 300B, to which the one system block is to be communicably coupled. The vision system 308V and/or scanning system 308S may be configured to determine the relative location between system blocks 300A, 300B to be coupled and the indicator(s) 308D provide an aural or visual stimulus to indicate when the system blocks 300A, 300B are properly located relative to one another for coupling.

While any given automation system block 300A, 300B, 300C may not employ all of the connectors or feed couplings 309, 310C, 311C of the operative common interface 301, the given automation system block 300A, 300B may include such connectors 309, 310C, 311C for passing signals (e.g., a pass-through PS—see FIG. 3) to a different system block, coupled thereto, that does employ those connectors 309, 310C, 311C (and signals communicated thereby). The common interface 378C of the controller side 378 may be invariant so that the common interface 378C of each system block 300 has the same connectors. For example, system block 300A is communicably coupled to system block 300B and system block 300B is communicably coupled to system block 300C. While system block 300B may not employ the safety signals from the common controller 393, system block 300B may serve as a pass-through, via the safety signal connectors 311C of system block 300B, for communicably coupling system blocks 300A and 300C so that safety signals may be communicated therebetween and to and from the common controller 393.

The operative common interface 301 of the automation system blocks 300A-300C of the exemplary laboratory facility or automatic or collaborative process facility 100 may substantially eliminate different connection/connector types found on conventional laboratory automation equipment. The operative common interface 301 may be designed into or retrofit into the laboratory automation equipment so that any suitable laboratory automation equipment may be interchangeable (e.g., in a plug-and-play manner) with any other laboratory automation equipment. The operative common interface 301 may be tailored to industrial equipment, such as of the laboratory automation industry or other suitable industry, so as to include not only power and communication, but also safety signals and physical location/attachment between the industrial equipment (such as the laboratory equipment described herein).

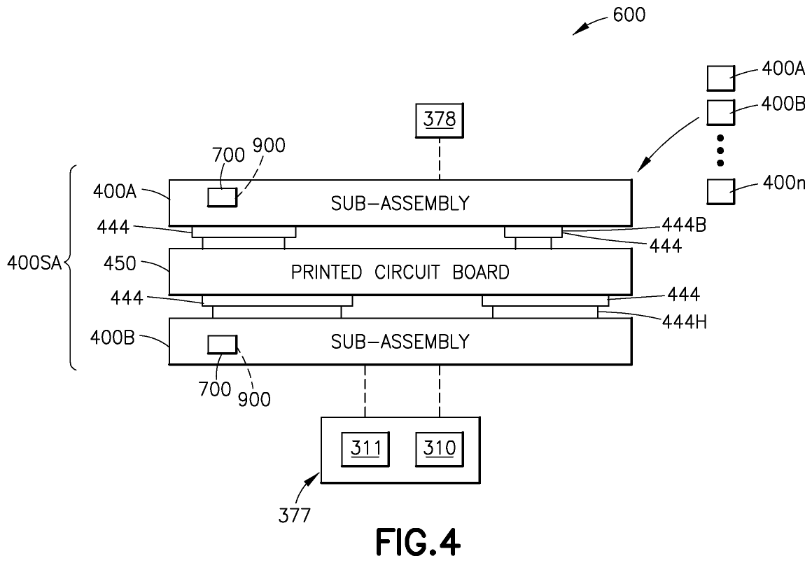

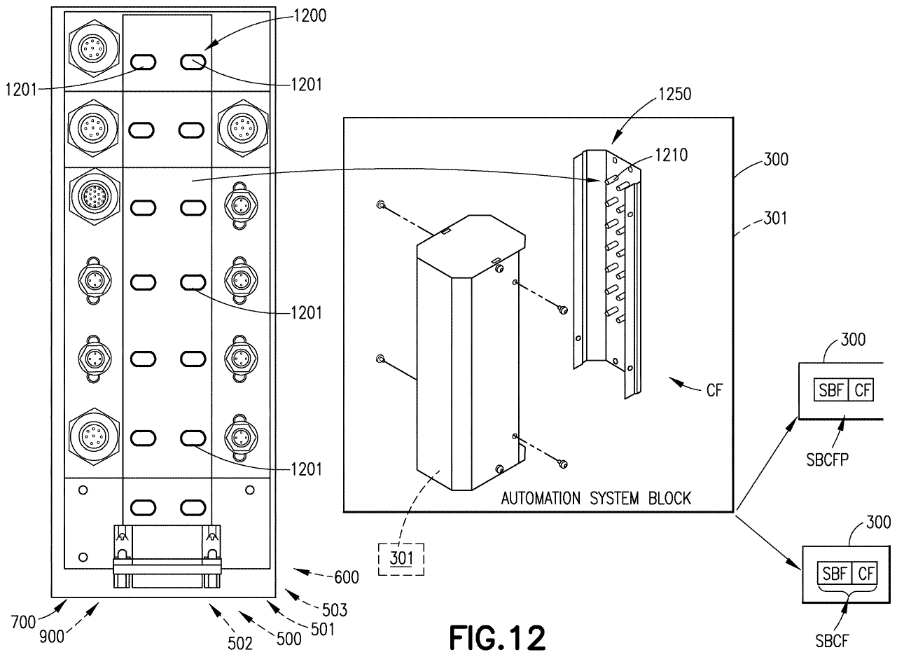

Still referring to FIG. 3 and also to FIG. 5 (which schematically illustrates an exemplary laboratory work cell 666, such as of the laboratory facilities illustrated in FIGS. 1 and 2 as noted above), each of the automation system blocks 300, 300A-300C and the common controller 393 may include (e.g., are configured to have installed/received therein, such as installed/received on/to a common frame SBCF or common frame portion SBCFP - see also FIG. 12) modularized functional sub-assemblies 400A-400n (which may be standardized or customized, e.g., assembly 400SA, in accordance with the present disclosure, and generally referred to as modularized functional sub-assemblies 400). A modularized functional sub-assembly may include one or more daughter boards 700, 900 described herein - see also FIG. 5) for at least safety signaling, mechanical assemblies (e.g., fluid distribution, etc.), communication signaling, and power distribution. One or more modularized functional sub-assemblies 400 (such as sub-assembly 400A and/or 400B in FIG. 4) may be included in or connected to the selectably variable communication signal connection interface 310, which effects configuration of the selectably variable communication signal connection interface 310 for conformity and connection with corresponding different selected module units of the assembly forming the different robotic architectures. One or more modularized functional sub-assemblies 400 (such as sub-assembly 400A and/or 400B in FIG. 4) may be included in or connected to the selectably variable common safety signal connection interface 311 which effects connection of the selectably variable common safety signal connection interface 311 with respective safety signal connectors of corresponding different selected module units of the assembly and sending of safety related commands, from the common controller 393 to at least one of the different selected robotic module units 386 forming different bot architectures. The common controller 393 may be configured by selecting one or more modularized functional sub-assemblies for inclusion therein.

The modularized functional sub-assemblies 400A-400n may provide for modularity, flexibility, and scalability of the respective automation system block's 300A-300C electrical, safety, communication, and mechanical systems, an example of which is illustrated in FIG. 5 where the common controller 393 is connected to secondary automation system blocks 300A, 300B, where each of the common controller 393 and secondary automation system blocks 300A, 300B have at least one assembly 500-503 (substantially similar to assembly 600 illustrated in FIG. 4) and each assembly 500-503 (which may be standardized assemblies formed by selected sub-assemblies 400) being formed of various respective modularized functional sub-assemblies (generally indicated in FIG. 5 as sub-assemblies 400). The assemblies 500, 501, 503 may be integrated in or connected to a respective operative common interface 301 (e.g., as part of one or more of the selectably variable common safety signal connection interface 311 and the selectably variable communication signal connection interface 310) of a respective system block 300A, 300B. Referring also to FIG. 4, different types of standard modularized functional sub-assemblies 400A-400n may be created for each of the electrical, fluid, and mechanical systems of the system blocks 300, where two or more of the standard modularized functional sub-assemblies are connected to each other by a customized (depending on which standard modularized functional sub-assemblies 400A-400n are being connected) printed circuit board 450 in a plug-and play manner (e.g., via any suitable socket/plug 444 connectors) to form a standardized or customized assembly 500-503, 600 (generally referred to as a assembly 400SA). The standardizing of the modularized functional sub-assemblies 400A-400n may provide for interconnectivity between sub-assemblies and/or minimizing a number of sub-assembly stock keeping units (SKUs). The configuration of the standard modularized functional sub-assemblies 400A-400n and the printed circuit board(s) 450 substantially eliminates any discrete wiring between sub-assemblies and facilitates assembly/disassembly of the components in the assembly 500-503, 600 in a plug-and-play manner by employing standard stocked (i.e., by the system block 300A-300C manufacturer) components. While FIG. 4 illustrates an assembly 600 having two stacked sub-assemblies 400A, 400B coupled to each other by printed circuit board 450, the assemblies 500-503, 600 may have any suitable number of modularized functional sub-assemblies 400A-400n stacked with each other where adjacent modularized functional sub-assemblies 400A-400n are coupled to each other by respective printed circuit boards 450.

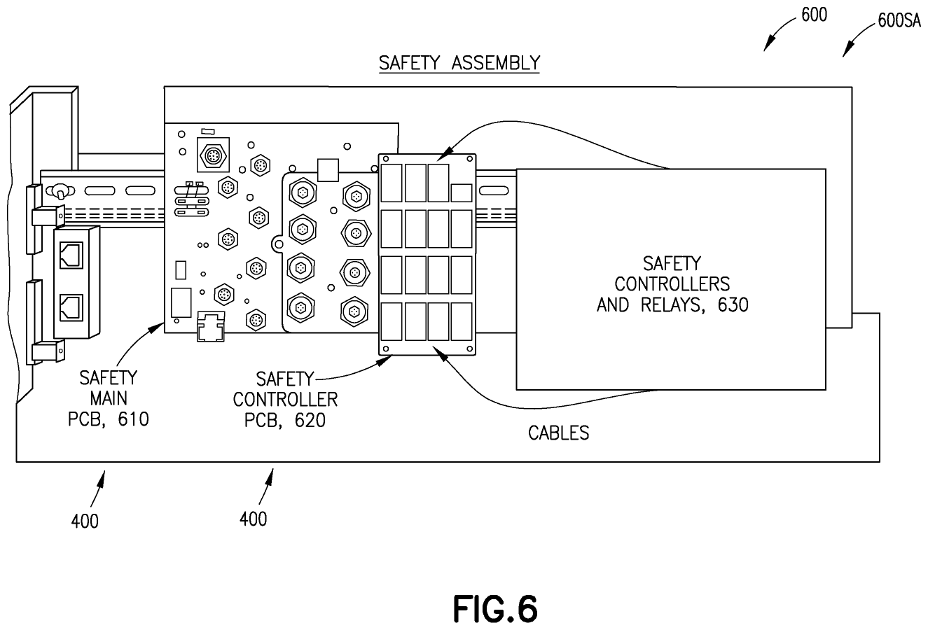

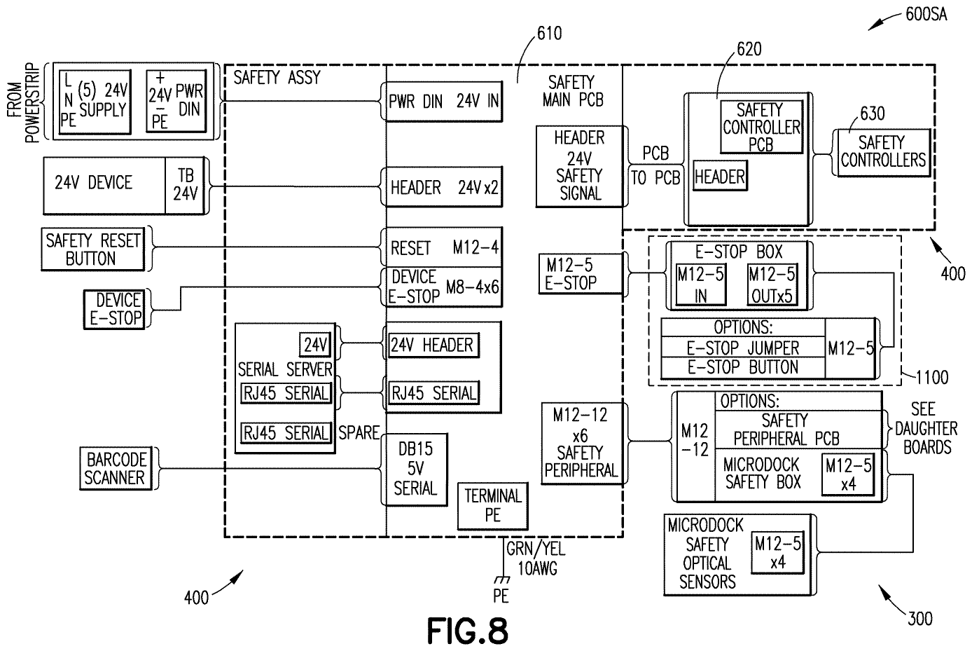

Referring to FIGS. 4 and 6, an exemplary assembly 600, including more than one sub-assembly 400A-400n is illustrated. The assembly 600 is configured as a safety assembly 600SA (see also FIG. 5) that may be included in, or otherwise form a part of, the common controller 393. The safety assembly 600SA may be configured to effect stoppage of the laboratory automation system's robots and devices (see FIGS. 1, 2, and 5). For exemplary purposes, the safety assembly 600SA includes a safety main printed circuit board (PCB) 610 and a safety controller printed circuit board (PCB) 620, although the safety assembly 600SA may have any suitable configuration. Safety signals for a given laboratory work cell 666 may be routed through the safety main PCB 610 which may allow for standardized connectors and cable connections instead of discrete automation wiring through terminal blocks as is found in conventional automated laboratory systems. The safety main PCB 610 may be the interface to the safety peripheral signals employed by the laboratory automation systems (e.g., robots, devices, etc., of the automation system blocks 300, 300A-300C as described with respect to FIGS. 1 and 2), where the common controller 393 is connected to the controller side of the operative common interface 301 of the automation system blocks 300, 300A-300C. The safety main PCB 610 may be configured to pass the safety signals to the safety controller PCB 620 through PCB-to-PCB connectors (such as of a respective customized printed circuit board 450). The configuration/architecture of the safety controller PCB 620 may be dependent on the configuration of the laboratory automation system/work cell 666. The safety main assembly 600SA may support multiple safety controller configurations with customized printed circuit boards 450 and customized cables, with the ability to expand/change to other safety controller options/configurations as desired. Any suitable cables may be employed to interface between the safety controller PCB 620 and the safety controllers/relays 630 as part of the plug-and-play architecture. Referring also to FIG. 8, the safety main assembly 600SA may provide for one or more of: standardized connects to facilitate plug-and-play peripheral device connections; substantial elimination of terminal block discrete wiring; flexible mounting options on laboratory automation system equipment; and easy upgrading of the respective laboratory automation system equipment.

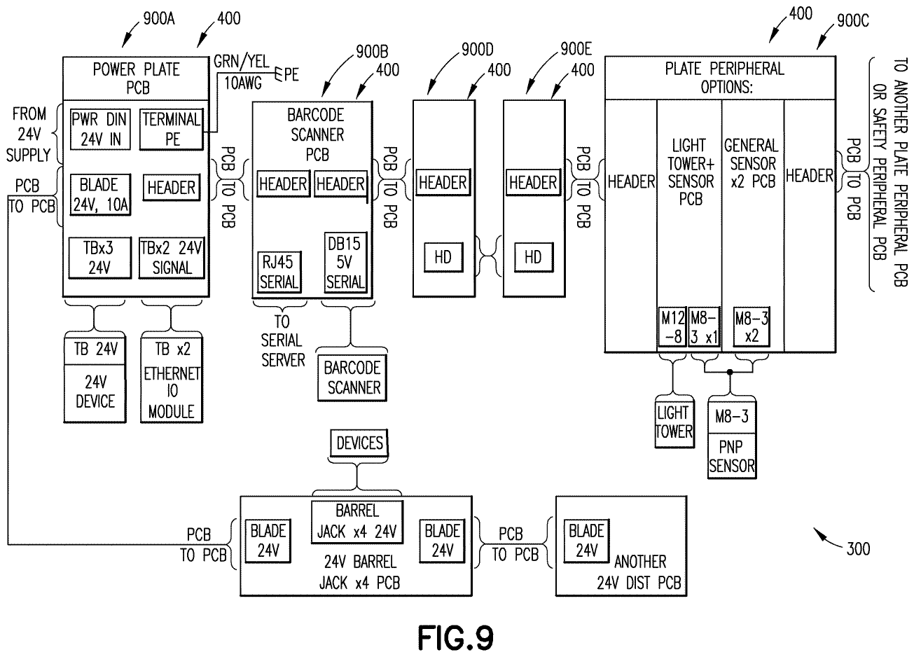

Referring to FIGS. 4, 7, and 9, examples of daughter boards 700A-700C, 900A-900E, that may be connected to the safety assembly 600SA (see FIG. 6), are schematically illustrated, although the daughter boards (generally referred to as daughter boards 700, 900, see also FIG. 5) may have any suitable configurations. The daughter boards 700, 900 may provide for one or more of: power distribution (e.g., 24 VDC or other direct current/alternating current); safety signaling from the safety assembly 600SA; and general input and output signaling. The daughter boards 700A-700C, 900A-900E may be coupled to each other (e.g., in an assembly 500-503, 600) through PCB-to-PCB connectors to pass the signals (e.g., header type connectors 444H, see FIG. 4) and power (e.g., blade type connectors 444B, see FIG. 4). The daughter boards (as an assembly or individually) may be mounted into any suitable mechanical sub-assembly 1250 (see FIG. 12) where various configurations of the daughter boards 700A-700C, 900A-900E may be provided. The mechanical sub-assembly 1250 may form a common frame CF or a portion of a common frame that is common to (i.e., the same for) each of the automation system blocks 300 described herein. For example, the mechanical sub-assembly 1250 may be a part of, coupled to, or otherwise integral to a system block frame SBF of each system block 300 (i.e., so that the automation system blocks 300 have a common frame SBCF or a common frame portion SBCFP that is the same for each system block 300). The common frame SBCF or a common frame portion SBCFP may facilitate a configuration of one automation system block 300 being the same or different from other automation system blocks 300 (see FIGS. 1, 2, and 5).

The same or different configurations of the automation system blocks 300 (and/or of the common controller 393) may be effected through, at least, selection of at least one or more of the different modularized functional sub-assemblies 400 (each including one or more respective daughter boards 700A-700C, 900A-900E) and/or selection of one or more of the standardized or customized assemblies 400SA formed by the sub-assemblies 400. Where an automation system block 300 includes more than one modularized functional sub-assembly 400, the modularized functional sub-assemblies may be coupled to each other with the PCB-to-PCB connectors, to form the standardized or customized assemblies 400SA which are installed in the automation system block 300 as a unit, as described herein (see FIG. 4). The modularized functional sub-assembly/assemblies 400 (and the selectably variable communication signal connection interface 310 or the selectably variable common safety signal connection interface 311 thereof) and/or the standardized or customized assemblies 400SA may be communicably connected to the operative common interface 301 in any suitable manner, such as with a PCB-to-PCB connector or any suitable cables.

The different standardized configurations of the modularized functional sub-assemblies 400 and/or assemblies 400SA may be effected by selecting and mounting predetermined printed circuit boards to each other with the PCB-to-PCB connectors described herein. The printed circuit boards forming a respective modularized functional sub-assembly 400 and/or assembly 400SA may be selected from one or more of the safety main PCB 610, the safety controller PCB 620, the safety stack 630, and/or one or more of the daughter boards 700A-700C, 900A-900E.

The various configurations of the modularized functional sub-assemblies 400 and/or assemblies 400SA (including one or more daughter boards 700A-700C, 900A-900E) may be effected where the daughter boards 700A-700C, 900A-900E each include a mounting hole pattern 1200 that is repeated on (i.e., common to or the same) each of the daughter boards 700A-700C, 900A-900E (see FIG. 12). For example, one or more the daughter boards 700A-700C, 900A-900E may be stacked with another daughter board 700A-700C, 900A-900E or other suitable board, such as the safety main assembly 600SA, so that mounting holes 1201 of the mounting hole pattern 1200 are aligned with one another, from board to board, allowing fasteners to pass through the stack of boards through respective aligned mounting holes 1201. The common frame SBCF or common frame portion SBCFP includes standoffs 1210 where each mounting hole 1201 is sized to allow passage of a standoff 1210 therethrough. The standoffs 1210 have a pattern that is the same as the mounting hole pattern 1200 so that the modularized functional sub-assemblies/assembly 400 may be connected to the common frame SBCF or common frame portion SBCFP and positioned on the common frame SBCF or common frame portion SBCFP through engagement between the mounting holes 1201 and standoffs 1210. Any suitable fasteners may engage the standoffs 1210 and be employed to secure the modularized functional sub-assemblies/assembly 400 to the common frame SBCF or common frame portion SBCFP. The fasteners may pass through the mounting holes 1201 of the mounting hole pattern 1200 into respective standoffs 1210. While mounting holes 1201 and standoffs 1210 are illustrated and described, the daughter boards 700, 900 (and the respective modularized functional sub-assembly 400) may be aligned with each other and connected to the common frame SBCF or common frame portion SBCFP in any suitable manner (e.g., such as by being fit into a recess of the common frame, clips, or other guiding/positioning structure).

The mechanical sub-assembly 1250 may include the operative common interface 301 (such as when retrofitting to an existing piece of automated laboratory equipment), the operative common interface 301 may include the mechanical sub-assembly 1250, or the operative common interface 301 may be connected to the mechanical sub-assembly 1250 in any suitable manner, where the operative common interface 301 and mechanical sub-assembly 1250 are coupled to or part of a respective system block frame SBF. The operative common interface 301 may have the mechanical sub-assembly integral thereto where the operative common interface 301 has the standoffs 1210 integrally formed therewith. The modularized functional sub-assemblies 400, 400A-400n may be connected to the operative common interface 301 in any suitable manner such as the PCB-to-PCB connectors described herein.

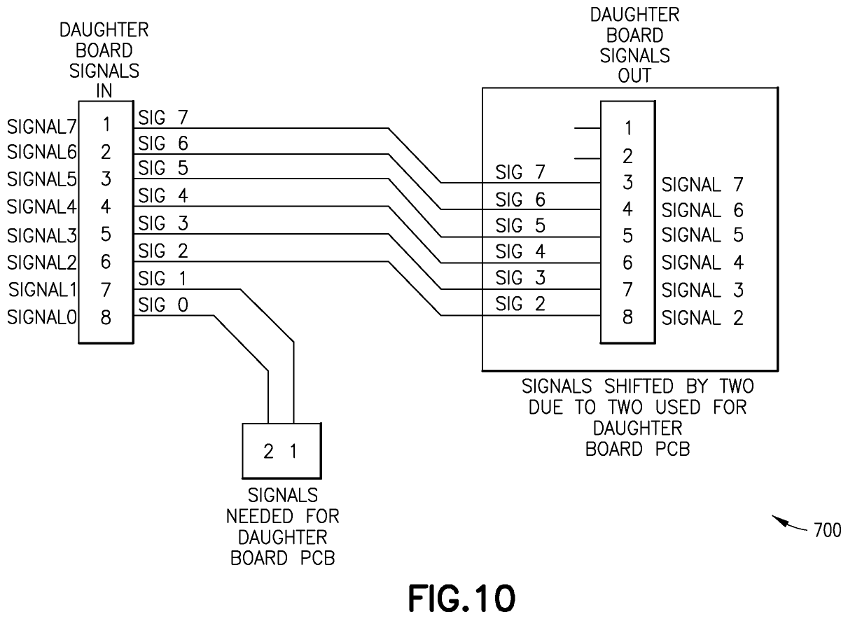

Still referring to FIGS. 4-9 and also to FIG. 10, passing general communication signals and/or safety signals between the printed circuit boards, such as the daughter boards 700, 900 of the modularized functional sub-assemblies 400, 400A-400n, may be effected in any suitable manner. For example, one or more PCB-to-PCB header type connectors 444 (see FIG. 4) may be provided for signaling where a signal shifting technique is employed. The signal shifting technique may be based on input/output signals desired for the connected printed circuit boards. FIG. 10 illustrates such signal shifting technique with respect to the inputs/outputs and signals desired for a given daughter board 700. The signal shifting technique may provide for modularity and flexibility so that the printed circuit boards may be connected in various configurations within the same mechanical sub-assembly space while providing for expandability to add additional printed circuit boards as desired. The signal shifting technique may be applied to general inputs, general outputs, and safety input/output loops. In the example illustrated in FIG. 10 the daughter board 700 has eight signal inputs, with two of the signal inputs being employed for operation of the daughter board 700. The daughter board 700 has eight signal outputs however, input signals 1-6 are shifted by two so that they are coupled/connected to the output as output signals 3-8.

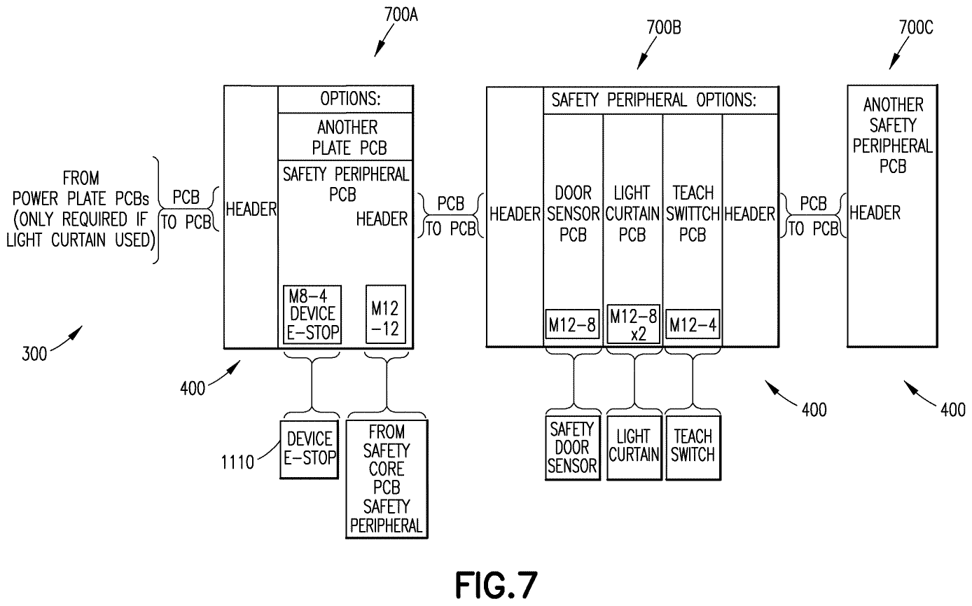

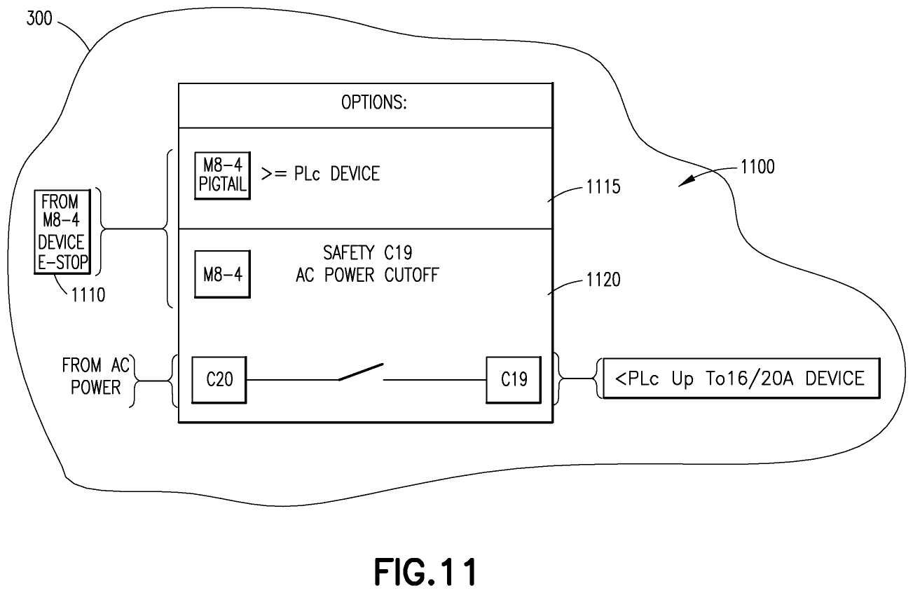

Referring to FIGS. 7, 8, and 11, one or more of the automation system blocks 300 may include any suitable emergency-stopping device 1100 that may include any suitable switch 1110 (e.g., configured for user actuation), a safety rated programmable logic controller (PLc) 1115 (or other suitable controller), and a power cutoff 1120. The safety rated PLc 1115 and a power cutoff 1120 may be coupled to or integrated into a daughter board, such as daughter board 700A (see FIG. 7), where the switch 1110 is coupled to one or more of the safety rated PLc 1115 and a power cutoff 1120 in any suitable manner. The safety rated PLc 1115 and a power cutoff 1120 may be coupled to or integrated into a safety main assembly, such as safety main assembly 600SA (see FIG. 8), where the switch 1110 is coupled to one or more of the safety rated PLc 1115 and a power cutoff 1120 in any suitable manner. With the integration or retrofit of the operative common interface 301 to the automation system blocks 300, automation system blocks that lack emergency stop functionality (e.g., non-safety rated automation system blocks) may be provided with such functionality by including the emergency-stopping device 1100 with (e.g., connected to or integrated with) the operative common interface 301. While the power cutoff 1120 is illustrated in FIG. 11 as an alternating current power cutoff, the power cutoff 1120 may be configured for direct current power cutoff applications.

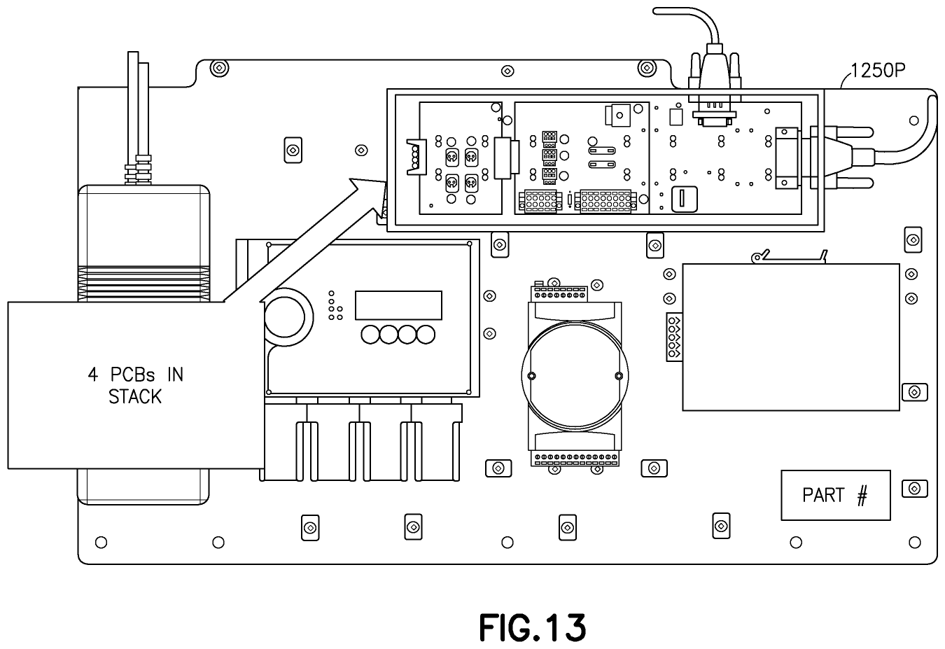

Referring again to FIGS. 1-3 and 12, the assemblies 500-503, 600 may be installed in a mechanical sub-assembly 1250, such as of a respective automation system block (generally illustrated in FIG. 12 as automation system block 300). While the mechanical sub-assembly 1250 is illustrated in FIG. 12 as a casing, the mechanical sub-assembly may have any suitable configuration, such as for example, a plate or board 1250P (see FIG. 13) that is integral to or coupled to the respective automation system block 300, or a blade type mounting bracket 1250B that is slid into a slotted frame of the respective automation system block 300 and fastened on its end (i.e., the end of the blade type mounting bracket) to the slotted frame.

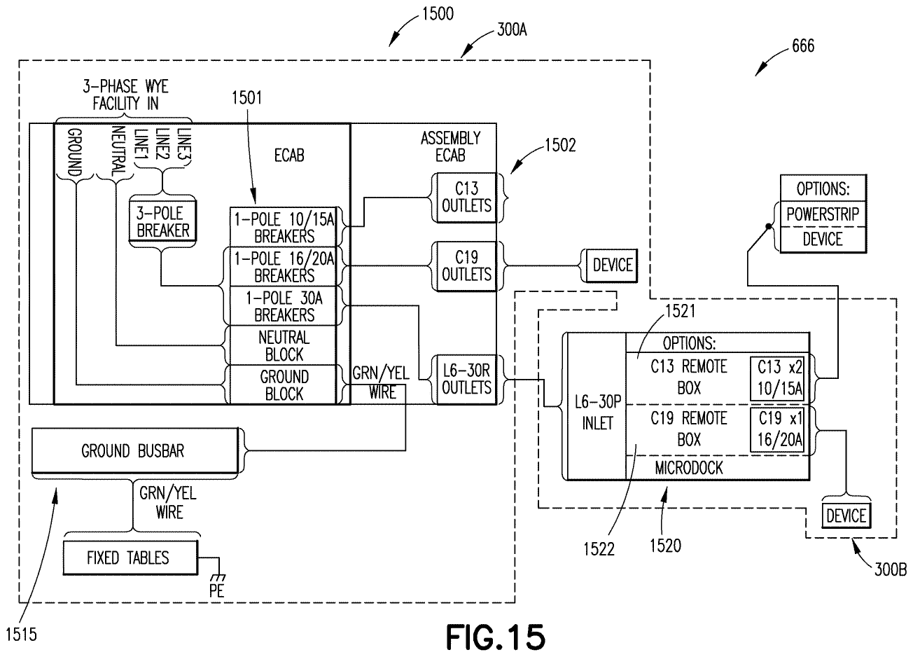

Referring to FIGS. 1-2 and 15, power distribution in a laboratory work cell 666 may be provided in a distributed manner in accordance with the present disclosure. The present disclosure provides for one or more electrical cabinets (some of which may be remote cabinets/micro-docks) that are distributed within a respective laboratory work cell 666. For example, a laboratory work cell 666 may have any suitable number of automation system blocks 300 (two automation system blocks 300A, 300B as shown for exemplary purposes in FIG. 15, although there may be more automation system blocks). A main electrical cabinet 1515 may be integrated into automation system block 300A, although the main electrical cabinet 1515 may be a standalone block of the laboratory work cell 666 that is coupled to other automation system blocks for distributing power thereto. One or more remote electrical boxes 1521, 1522 may be integrated with another automation system block 300B of the laboratory work cell 666, where the remote electrical boxes 1521, 1522 receive power from the main electrical cabinet 1515 and distribute the received power to the device(s) of the respective automation system block 300B.

The main electrical cabinet 1515 may include one or more of circuit breakers 1501, power cord outlets 1502, and grommets for the respective power cords coupled to the power cord outlets. The power cord outlets 1502 may be configured to support global voltage power sources so as to provide flexibility of use of the automation system blocks with the power systems of different countries. The remote electrical boxes 1521, 1522 may be configured as a micro-dock or sub-electrical cabinet 1520 that is integrated to the other automation system block 30B, although the micro-dock 1520 may be a standalone system block that may be placed at any suitable location within the laboratory work cell 666. The micro-dock 1520 is coupled to a respective power outlet 1502 of the main power cabinet 1515 where the remote boxes 1521, 1522 distribute power to respective devices of the respective automation system block 300B (or more than one other automation system block).

Referring again to FIG. 3, the present disclosure provides for retrofitting the operative common interface 301 to automation system block not manufactured with such operative common interface 301. For example, automation system block 300B may be retrofit, through employment of an adapter 399, to include the operative common interface 301. The adapter 399 may include any suitable connection interfaces (e.g., I/O, TCP/IP, serial, parallel etc., as described herein) 399C for connection to laboratory automation machines (such as those robotic module units 386 described herein). The adapter 399 may include a processor 399P configured to receive generalized laboratory automation commands (such as from any suitable laboratory controller and/or the safety main assembly 600SA) and instructing the connected laboratory automation machines to execute their corresponding lower level tasks to accomplish the generalized laboratory automation instructions. The adapter 399 may include a user interface 399U configured to provide instructions and indications to a human user. The operative common interface 301 may include the user interface 399U in a manner similar to that of the adapter 399 or the automation system block 300 may include any suitable user interface configured to provide instructions and indications to a human user. The instructions and indications include, but are not limited to, system status and instructions for a human to perform manual steps as part of a broader automated routine.

The adapter 399 may include, or otherwise provide for integration of, various sensors 399S (e.g., that would otherwise be included in an automation system block 300 of the present disclosure) configured to gather data regarding the laboratory automation machines (or the laboratory in general) and report that data back to the suitable laboratory controller for processing and including with scientific results. The adapter 399 may provide for the connection of laboratory automation machines to a unified automated system without advanced networking/wiring knowledge. The adapter 399 may provide for rapid interchangeability of the laboratory automation machines. The adapter 399 may provide for human operators to become a seamless part of the automated system (e.g., by providing instruction to the human operators to work/interface with the laboratory automation machines in an automatic or collaborative manner to achieve completion of laboratory tasks).

Referring to FIGS. 1, 2, and 3, the laboratory facility 100 or tool 200A may include one or more automation system blocks 300, such as tables, that include shelves 272 on which processing equipment may be placed. The present disclosure provides for these shelves 272 of the respective automation system blocks 300 to be user installable and/or adjustable in height. The shelves are installable/adjustable so that with installation/adjustment of the shelves 272 the electrical/communication signaling connections are shifted, e.g., via the operative common interface 301 of the respective automation system block 300, to the new shelf location on the automation system block 300.

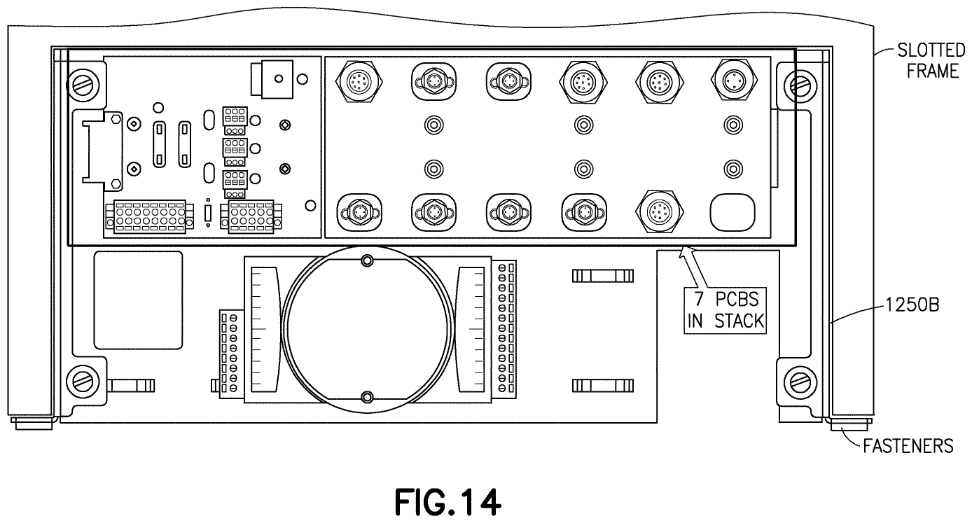

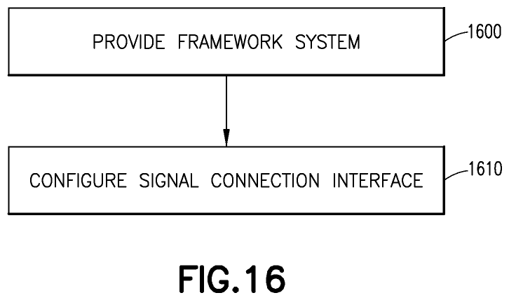

Referring to FIGS. 1-16, and in particular to FIGS. 1-3 and 16, an exemplary method will be described in accordance with the present disclosure. The method includes providing a framework system 333 (FIG. 16, Block 1600) for robotic architecture for a laboratory space (e.g., such as laboratory facility 100 and/or tool 200A). The framework system 333 may be as described herein. For example, the framework system 333 includes a chassis 333C and an operative common interface 301. The chassis 333C provides a common selectable variable mounting interface 305 for selectably mounting different robotic module units 386 (such as robotic arms, specimen analyzers, etc. such as the different automated processing equipment described above with respect to FIGS. 1 and 2) of the robotic architecture to the chassis 333C so as to assembly different selectable robotic module units 386 to the chassis 333C forming different robotic architectures (e.g., such as described with respect to FIGS. 1 and 2), each having different bot architecture characteristics. The different robotic module units 386 each have different robotic characteristics and is mounted to and removed from the chassis 333C as a unit. The different robotic module units 386 may be selected from a number of different robotic module units 386A-386n for coupling to the chassis 333C. The operative common interface 301 is connected to the chassis 333C in any suitable manner (such as with any suitable fasteners). The operative common interface operatively interfaces the assembly of different selected robotic module units 386 and a common controller 393 of the different robotic module units 386. The operative common interface 301 has a module input/output (I/O) side 377 and a controller side 378. At the module input/output side 377, the operative common interface 301 has a common communication signal connection interface 310 that is selectably variable (as described herein), and a common safety signal connection interface 311 that is selectably variable (as described herein).

The common communication signal connection interface 310 is configured (FIG. 16, Block 1610) to conform and communicably connect with corresponding different selected module units 386 of the assembly forming the different robotic architectures by selecting different connectors 310C (as described herein) so as to provide the common communication signal connection interface 310 with the different connectors 310C, having different coupling characteristics.

As described herein, the common safety signal connection interface 311 is configured so as to communicably connect (e.g., through any suitable connectors 311C) with respective safety signal connectors 386SC of corresponding different selected robotic module units 386 of the assembly of different selectable robotic module units (e.g., such as forming a robotic processing vehicle, process station, process tool, etc. described herein) and send a safety related command, from the common controller 393, of the different selected robotic module units 386, to at least one of the different selected robotic module units 386 forming the different robotic architectures (e.g., for at least one of the different robotic architectures, the safety related command is sent from the common controller to the at least one different selected robotic module unit(s) 386 of a respective robotic architecture (e.g., process vehicle, process station, process tool, etc.) of which the selected robotic module unit(s) 386 are a part). The controller side 378, of the operative common interface 301, has a common interface 378C having a common coupling 378L so as to couple with the common controller 393 and so that input/output signals, including communication signals and safety related commands, are communicated to and from the common controller 393 and to and from the respective different selected robotic module units 386 of the different robotic architectures. The common coupling 378L is common to each of the different robotic architectures and has a substantially invariant configuration.

The method may include, individually or in any combination with each other, or in combination with any of the features described herein, one or more of: common selectable variable mounting interface 305, the selectably variable communication signal connection interface 310, the selectably variable common safety signal connection interface 311, and the controller side 378 common interface 378C (that is substantially invariant with respect to each of the different robotic architectures) may provide a framework system 333 that defines a plug and play, modular, interchangeable, and scalable (via variance in the number of and type of the different selected robotic module units assembled) robotic architecture; the operative common interface 301 has pneumatic coupling connections (see fluid connectors or feed couplings 309) for respective different selected module units 386 assembled; the different connectors 310C, of the common communication signal connection interface 310, include one or more of serial type networking connectors and parallel type networking connectors; the serial type networking connectors of the common communication signal connection interface 310 include one or more of: I2C, RS-232, RS-485, USB, UART, and TTL connectors; the parallel type networking connectors of the common communication signal connection interface 310 include one or more of: PCT, SCSI, LPT, and IDE connectors; the common safety signal connection interface 311 includes one or more of serial type connectors and parallel type connectors (see connectors 311C); the serial type networking connectors of the common safety signal connection interface 311 include one or more of: I2C, RS-232, RS-485, USB, UART, and TTL connectors; the parallel type networking connectors of the common safety signal connection interface 311 include one or more of: PCT, SCSI, LPT, and IDE connectors; at the module input/output side 377 the operative common interface 301 has a pneumatic feed manifold 309M with different pneumatic feed couplings or fluid connectors 309 with feed characteristics that conform with respective pneumatic feed demands of different robotic module units 386; the feed manifold 309M includes at least one of a nitrogen gas feed coupling, a compressed air feed coupling, a carbon dioxide gas feed coupling, and a vacuum feed coupling; at least one of the different connectors 310C of the common communication signal connection interface 310 has a plug and play connection characteristic; at least one of the different connectors 310C of the common communication signal connection interface 310 is configured so as to, upon coupling, initialize an identification query of at least one of the different robotic module units 386 coupled thereto, and disposed to receive a self-identification signal (from the at least one of the different robotic module units 386 coupled thereto) in reply; the common communication signal connection interface 310, or the selectable variable mounting interface 305 has an intelligent indication signal system 308 disposed to send a signal to the common controller 393 of accepted installation (e.g., at least one of mounting, communication signal coupling, and safety signal coupling) of at least one robotic module unit 386 in the framework system 333 so as to integrate the at least one robotic module unit via the framework system 333 to the robotic architecture; the intelligent indication system 308 includes at least one of a vision system 308V and scanning system 308S disposed so as to read a readable fiducial (vision fiducial, barcode, QR code, etc. as described herein) associated with and that embodies identification information of the at least one robotic module unit 386 that is acceptably installed; the common communication signal connection interface 310 includes at least one M12 connector, a TTL protocol connector, and RS-232 connector; the common safety signal connection interface 311 includes at least one M12 connector, a TTL protocol connector, a RS-232 connector, and a safety rated connector; the selectable variable mounting interface 305 has at least one interface mount 306, 307 that combined with at least one corresponding communication connector 310C of the common communication signal connection interface 310, and with at least one safety signal connector 311C of the common safety signal connection interface 311 form a common framework integration coupling 333P that couples at least one of the robotic module units 386 to the robotic architecture via the framework system 333.

The following are provided in accordance with the present disclosure and may be employed individually, in any combination with each other, and/or in any combination with the features described above:

In accordance with the present disclosure, a framework system, for robotic architecture for a laboratory space, is provided. The framework system includes: a chassis providing a common selectable variable mounting interface for selectably mounting different module units of the robotic architecture to the chassis so as to assemble different selectable module units to the chassis forming different bot architectures; an operative common interface connected to the chassis, the operative common interface operatively interfacing the assembly of different selected module units and a common controller of the different robotic architectures, wherein the operative common interface has a module input/output side; and at the module input/output side, the common interface has a common communication signal connection interface that is selectably variable, and a common safety signal connection interface that is selectably variable; the common communication signal connection interface having different connectors, with different coupling characteristics that, which different connectors are selectable so as to configure the common communication signal connection interface to conform and communicably connect with corresponding different selected module units of the assembly forming the different robotic architectures; and the common safety signal connection interface is configured so as to communicably connect with respective safety signal connectors of corresponding different selected module units of the assembly and send a safety related command, from the common controller to at least one of the different selected module units forming different bot architectures; and the operative common interface has a controller side with a common interface having a common coupling so as to couple with the common controller and so that input/output signals, including communication signals and safety related commands, are communicated to and from the common controller and to and from respective different selected module units of the different robotic architectures.

The framework system may include, individually, in any combination with each other, and/or in any combination with the features described herein, one or more of: the common selectable variable mounting interface, the selectably variable communication signal connection interface, the selectably variable common safety signal connection interface, and the controller side common interface provide a framework system that defines a plug and play, modular, interchangeable, and scalable (via variance in the number of and type of the different selected module units assembled) robotic architecture; the operative common interface has pneumatic coupling connections for respective different selected module units assembled; the different connectors, of the common communication signal connection interface, include one or more of serial type networking connectors and parallel type networking connectors; the serial type networking connectors, of the common communication signal connection interface, include one or more of: I2C, RS-232, RS-485, USB, UART, and TTL protocol connectors; the parallel type networking connectors, of the common communication signal connection interface, include one or more of: PCT, SCSI, LPT, and IDE connectors; the common safety signal connection interface includes one or more of serial type connectors and parallel type connectors; the serial type networking connectors, of the common safety signal connection interface, include one or more of: I2C, RS-232, RS-485, USB, UART, and TTL protocol connectors; the parallel type networking connectors, of the common safety signal connection interface, include one or more of: PCT, SCSI, LPT, and IDE connectors; at the module input/output side the operative common interface has a pneumatic feed manifold with different pneumatic feed couplings with feed characteristics that conform with respective pneumatic feed demands of different module units; the feed manifold includes at least one of a nitrogen gas feed coupling, a compressed air feed coupling, a carbon dioxide gas feed coupling, and a vacuum coupling; at least one of the different connectors of the common communication signal connection interface has a plug and play connection characteristic; at least one of the different connectors of the common communication signal connection interface is configured so as to, upon coupling, initialize an identification query of at least one of the different module units coupled thereto, and disposed to receive a self-identification signal in reply; the common communication signal connection interface, or the selectable variable mounting interface has an intelligent indication system disposed to send a signal to the common controller of accepted installation of at least one module unit in the framework system so as to integrate the at least one module unit via the framework system to the bot architecture; the intelligent indication system includes at least one of a vision or scanning system disposed so as to read a readable fiducial associated with and that embodies identification information of the at least one module unit that is acceptably installed; the common communication signal connection interface includes at least one M12 connector, a TTL protocol connector, and RS-232 connector; the common safety signal connection interface includes at least one M12 connector, a TTL protocol connector, RS232 connector, and safety rated connector (contactless safety rated, IR sensor); and the selectable variable mounting interface has at least one interface mount that combined with at least one corresponding communication connector of the common communication signal connection interface, and with at least one safety signal connector of the common safety signal connection interface form a common framework integration coupling that couples at least one of the module units to the robotic architecture via the framework system.

In accordance with the present disclosure, a method is provided. The method includes: providing a framework system for robotic architecture for a laboratory space, the framework system having: a chassis providing a common selectable variable mounting interface for selectably mounting different module units of the robotic architecture to the chassis so as to assemble different selectable module units to the chassis forming different bot architectures; an operative common interface connected to the chassis, the operative common interface operatively interfacing the assembly of different selected module units and a common controller of the different robotic architectures, wherein the operative common interface has a module input/output side; and at the module input/output side, the common interface has a common communication signal connection interface that is selectably variable, and a common safety signal connection interface that is selectably variable; configuring the common communication signal connection interface to conform and communicably connect with corresponding different selected module units of the assembly forming the different robotic architectures by selecting different connectors so as to provide the common communication signal connection interface with the different connectors, having different coupling characteristics; and wherein: the common safety signal connection interface communicably connects with respective safety signal connectors of corresponding different selected module units of the assembly and sends a safety related command, from the common controller to at least one of the different selected module units forming different bot architectures; and the operative common interface has a controller side with a common interface having a common coupling that couples with the common controller and communicates input/output signals, including communication signals and safety related commands, to and from the common controller and to and from respective different selected module units of the different robotic architectures.

The method may include, individually, in any combination with each other, and/or in any combination with the features described herein, one or more of: the common selectable variable mounting interface, the selectably variable communication signal connection interface, the selectably variable common safety signal connection interface, and the controller side common interface provide a framework system that defines a plug and play, modular, interchangeable, and scalable robotic architecture; the operative common interface has pneumatic coupling connections for respective different selected module units assembled; the different connectors, of the common communication signal connection interface, include one or more of serial type networking connectors and parallel type networking connectors; the serial type networking connectors include one or more of: I2C, RS-232, RS-485, USB, UART, and TTL protocol connectors, and the parallel type networking connectors include one or more of: PCT, SCSI, LPT, and IDE connectors; the common safety signal connection interface includes one or more of serial type connectors and parallel type connectors; the serial type networking connectors include one or more of: I2C, RS-232, RS-485, USB, UART, and TTL protocol connectors, and the parallel type networking connectors include one or more of: PCT, SCSI, LPT, and IDE connectors; at the module input/output side the operative common interface has a pneumatic feed manifold with different pneumatic feed couplings with feed characteristics that conform with respective pneumatic feed demands of different module units; the feed manifold includes at least one of a nitrogen gas feed coupling, a compressed air feed coupling, a carbon dioxide gas feed coupling, and a vacuum coupling; at least one of the different connectors of the common communication signal connection interface has a plug and play connection characteristic; at least one of the different connectors of the common communication signal connection interface is configured so as to, upon coupling, initialize an identification query of at least one of the different module units coupled thereto, and disposed to receive a self-identification signal in reply; the common communication signal connection interface, or the selectable variable mounting interface has an intelligent indication system disposed to send a signal to the common controller of accepted installation of at least one module unit in the framework system so as to integrate the at least one module unit via the framework system to the bot architecture; the intelligent indication system includes at least one of a vision or scanning system disposed so as to read a readable fiducial associated with and that embodies identification information of the at least one module unit that is acceptably installed; the common communication signal connection interface includes at least one M12 connector, a TTL protocol connector, and RS-232 connector; the common safety signal connection interface includes at least one M12 connector, a TTL protocol connector, RS232 connector, and safety rated connector; and the selectable variable mounting interface has at least one interface mount that combined with at least one corresponding communication connector of the common communication signal connection interface, and with at least one safety signal connector of the common safety signal connection interface form a common framework integration coupling that couples at least one of the module units to the robotic architecture via the framework system.

It should be understood that the foregoing description is only illustrative of the present disclosure. Various alternatives and modifications can be devised by those skilled in the art without departing from the present disclosure. Accordingly, the present disclosure is intended to embrace all such alternatives, modifications and variances that fall within the scope of any claims appended hereto. Further, the mere fact that different features are recited in mutually different dependent or independent claims does not indicate that a combination of these features cannot be advantageously used, such a combination remaining within the scope of the present disclosure.

What is claimed is:

1. A framework system for robotic architecture for a laboratory space, the framework system comprising:
a chassis providing a common selectable variable mounting interface for selectably mounting different module units of the robotic architecture to the chassis so as to assemble different selectable module units to the chassis forming different bot architectures;
an operative common interface connected to the chassis, the operative common interface operatively interfacing the assembly of different selected module units and a common controller of the different robotic architectures, wherein the operative common interface has a module input/output side; and
and at the module input/output side, the common interface has a common communication signal connection interface that is selectably variable, and a common safety signal connection interface that is selectably variable;
the common communication signal connection interface having different connectors, with different coupling characteristics that, which different connectors are selectable so as to configure the common communication signal connection interface to conform and communicably connect with corresponding different selected module units of the assembly forming the different robotic architectures; and
the common safety signal connection interface is configured so as to communicably connect with respective safety signal connectors of corresponding different selected module units of the assembly and send a safety related command, from the common controller to at least one of the different selected module units forming different bot architectures; and
the operative common interface has a controller side with a common interface having a common coupling so as to couple with the common controller and so that input/output signals, including communication signals and safety related commands, are communicated to and from the common controller and to and from respective different selected module units of the different robotic architectures.

2. The framework system of claim 1, wherein the common selectable variable mounting interface, the selectably variable communication signal connection interface, the selectably variable common safety signal connection interface, and the controller side common interface provide a framework system that defines a plug and play, modular, interchangeable, and scalable (via variance in the number of and type of the different selected module units assembled) robotic architecture.

3. The framework system of claim 1, wherein the operative common interface has pneumatic coupling connections for respective different selected module units assembled.

4. The framework system of claim 1, wherein the different connectors, of the common communication signal connection interface, include one or more of serial type networking connectors and parallel type networking connectors.

5. The framework system of claim 4, wherein:
the serial type networking connectors include one or more of: I2C, RS-232, RS-485, USB, UART, and TTL connectors; and
the parallel type networking connectors include one or more of: PCT, SCSI, LPT, and IDE connectors.

6. The framework system of claim 1, wherein the common safety signal connection interface includes one or more of serial type connectors and parallel type connectors.

7. The framework system of claim 6, wherein:
the serial type networking connectors include one or more of: I2C, RS-232, RS-485, USB, UART, and TTL connectors; and
the parallel type networking connectors include one or more of: PCT, SCSI, LPT, and IDE connectors.

8. The framework system of claim 1, wherein at the module input/output side the operative common interface has a pneumatic feed manifold with different pneumatic feed couplings with feed characteristics that conform with respective pneumatic feed demands of different module units.

9. The framework system of claim 8, wherein the feed manifold includes at least one of a nitrogen gas feed coupling, a compressed air feed coupling, a carbon dioxide gas feed coupling, and a vacuum feed coupling.

10. The framework system of claim 1, wherein at least one of the different connectors of the common communication signal connection interface has a plug and play connection characteristic.

11. The framework system of claim 10, wherein at least one of the different connectors of the common communication signal connection interface is configured so as to, upon coupling, initialize an identification query of at least one of the different module units coupled thereto, and disposed to receive a self-identification signal in reply.

12. The framework system of claim 1, wherein the common communication signal connection interface, or the selectable variable mounting interface has an intelligent indication (signal) system disposed to send a signal to the common controller of accepted installation (at least one of mounting, comm signal coupling and safety signal coupling) of at least one module unit in the framework system so as to integrate the at least one module unit via the framework system to the bot architecture.

13. The framework system of claim 12, wherein the intelligent indication system includes at least one of a vision system or scanning system disposed so as to read a readable fiducial (vision fiducial, barcode, QR code) associated with and that embodies identification information of the at least one module unit that is acceptably installed.

14. The framework system of claim 1, wherein the common communication signal connection interface includes at least one M12 connector, a TTL protocol connector, and RS-232 connector.

15. The framework system of claim 1, wherein the common safety signal connection interface includes at least one M12 connector, a TTL protocol connector, RS232 connector, and safety rated connector (contactless safety rated, IR sensor).

16. The framework system of claim 1, wherein the selectable variable mounting interface has at least one interface mount that combined with at least one corresponding communication connector of the common communication signal connection interface, and with at least one safety signal connector of the common safety signal connection interface form a common framework integration coupling that couples at least one of the module units to the robotic architecture via the framework system.

17. A method comprising:
providing a framework system for robotic architecture for a laboratory space, the framework system having:
a chassis providing a common selectable variable mounting interface for selectably mounting different module units of the robotic architecture to the chassis so as to assemble different selectable module units to the chassis forming different bot architectures;
an operative common interface connected to the chassis, the operative common interface operatively interfacing the assembly of different selected module units and a common controller of the different robotic architectures, wherein the operative common interface has a module input/output side; and
and at the module input/output side, the common interface has a common communication signal connection interface that is selectably variable, and a common safety signal connection interface that is selectably variable;
configuring the common communication signal connection interface to conform and communicably connect with corresponding different selected module units of the assembly forming the different robotic architectures by selecting different connectors so as to provide the common communication signal connection interface with the different connectors, having different coupling characteristics; and
wherein:
the common safety signal connection interface communicably connects with respective safety signal connectors of corresponding different selected module units of the assembly and sends a safety related command, from the common controller to at least one of the different selected module units forming different bot architectures; and
the operative common interface has a controller side with a common interface having a common coupling that couples with the common controller and communicates input/output signals, including communication signals and safety related commands, to and from the common controller and to and from respective different selected module units of the different robotic architectures.

18. The method of claim 17, wherein the common selectable variable mounting interface, the selectably variable communication signal connection interface, the selectably variable common safety signal connection interface, and the controller side common interface provide a framework system that defines a plug and play, modular, interchangeable, and scalable robotic architecture.

19. The method of claim 17, wherein the operative common interface has pneumatic coupling connections for respective different selected module units assembled.

20. The method of claim 17, wherein the different connectors, of the common communication signal connection interface, include one or more of serial type networking connectors and parallel type networking connectors.

21. The method of claim 20, wherein:
the serial type networking connectors include one or more of: I2C, RS-232, RS-485, USB, UART, and TTL protocol connectors; and
the parallel type networking connectors include one or more of: PCT, SCSI, LPT, and IDE connectors.

22. The method of claim 17, wherein the common safety signal connection interface includes one or more of serial type connectors and parallel type connectors.

23. The method of claim 22, wherein:
the serial type networking connectors include one or more of: I2C, RS-232, RS-485, USB, UART, and TTL protocol connectors; and
the parallel type networking connectors include one or more of: PCT, SCSI, LPT, and IDE connectors.

24. The method of claim 17, wherein at the module input/output side the operative common interface has a pneumatic feed manifold with different pneumatic feed couplings with feed characteristics that conform with respective pneumatic feed demands of different module units.

25. The method of claim 24, wherein the feed manifold includes at least one of a nitrogen gas feed coupling, a compressed air feed coupling, a carbon dioxide gas feed coupling, and a vacuum feed coupling.

26. The method of claim 17, wherein at least one of the different connectors of the common communication signal connection interface has a plug and play connection characteristic.

27. The method of claim 26, wherein at least one of the different connectors of the common communication signal connection interface is configured so as to, upon coupling, initialize an identification query of at least one of the different module units coupled thereto, and disposed to receive a self-identification signal in reply.

28. The method of claim 17, wherein the common communication signal connection interface, or the selectable variable mounting interface has an intelligent indication system disposed to send a signal to the common controller of accepted installation of at least one module unit in the framework system so as to integrate the at least one module unit via the framework system to the bot architecture.

29. The method of claim 28, wherein the intelligent indication system includes at least one of a vision system and scanning system disposed so as to read a readable fiducial associated with and that embodies identification information of the at least one module unit that is acceptably installed.

30. The method of claim 17, wherein the common communication signal connection interface includes at least one M12 connector, a TTL protocol connector, and RS-232 connector.

31. The method of claim 17, wherein the common safety signal connection interface includes at least one M12 connector, a TTL protocol connector, RS-232 connector, and safety rated connector (contactless safety rated, IR sensor).

32. The method of claim 17, wherein the selectable variable mounting interface has at least one interface mount that combined with at least one corresponding communication connector of the common communication signal connection interface, and with at least one safety signal connector of the common safety signal connection interface form a common framework integration coupling that couples at least one of the module units to the robotic architecture via the framework system.
